(19) United States
(12) Patent Application Publication
(10) Pub. No.: US 2006/0149957 A1
(43) Pub. Date: Jul. 6, 2006

(54) Method for initializing a ram of an electronic device

(75) Inventor: Hyun Joon Cha, Seoul (KR)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: PANTECH CO., LTD.

(21) Appl. No.: 11/342,191

(22) Filed: Jan. 27, 2006

(30) Foreign Application Priority Data
Jan. 2, 2005 (KR) 10-2005-0008950

(51) Int. Cl. G06F 9/24

(52) U.S. Cl. 713/1

(57) ABSTRACT

Disclosed is a method for initializing a RAM of an electronic device capable of reducing a time consumed for a RAM initializing process to rapidly make progress a boot-up process of an electronic device such as mobile communication terminal. The method comprises steps of filling a zero-initialize region of the RAM with ‘0’; and copying a code of a ROM of the electronic device to a code region of the RAM, wherein in the step of filling the zero-initialize region with ‘0’, if one or more addresses of the N addresses constituting the zero-initialize region of the RAM are not filled with ‘0’, the N addresses are sequentially filled with ‘0’, and in the copying step, if the code is not copied to one or more addresses of the N addresses constituting the zero-initialize region of the RAM, the code of the ROM is sequentially copied to the N addresses.

### CROSS-REFERENCE TO RELATED APPLICATION

The present application is claiming priority of Korean Patent Application No. 10-2005-0008950 filed on Feb. 1, 2005, the content of which is herein incorporated by reference.

### BACKGROUND OF THE INVENTION

1. Field of the Invention

The present invention relates to a method for initializing a RAM of an electronic device, and more particularly to a method for initializing a RAM of an electronic device capable of minimizing a time consumed for a RAM initializing process to rapidly make progress a boot-up process of an electronic device such as mobile communication terminal.

2. Description of the Prior Art

In a typical electronic device, including a mobile communication terminal, having an operating system mounted therein, a boot-up process is meant by a series of processes until an initial scene is displayed since power is applied. The boot-up process can be divided to 1) a Central processing unit initializing process, 2) a RAM initializing process, 3) a Hardware initializing process and 4) a Task initializing process.

The Central processing unit initializing process is a process of initializing a central processing unit of an electronic device such as micro processor unit (MPU) or micro controller unit (MCU). The RAM initializing process is a process of filling a zero-initialize region of a RAM with ‘0’ and then copying a code stored in an electrically erasable programmable read only memory (EEPROM) of an electronic device, for example a mobile communication terminal to a code region of the RAM. The Hardware initializing process is a process of initializing all hardwares of a mobile communication terminal. The Task initializing process is a process of initializing an operating system (OS) of a mobile station module in a case of a mobile communication terminal.

Among the initializing processes constituting the boot-up process, the processes requiring the most time are the RAM initializing process and the task initializing process.

The RAM initializing process is as follows. FIG. 1 is a flow chart for explaining a RAM initializing process of a mobile communication terminal according to the prior art.

First, as shown in FIG. 1, when a RAM initializing process is started, it is determined whether all addresses of a zero-initialize region (ZI) are filled with ‘0’ (S101). As the determination result in the step of S101, if one or more addresses of the zero-initialize region are not filled with ‘0’, one of the addresses that are not filled with ‘0’ is with filled with ‘0’ (S102). Then, it is again determined whether all addresses of the zero-initialize region (ZI) are filled with ‘0’ (S101). Like this, the steps of S101 and S102 are repeated to fill all the addresses of the zero-initialize region. At this time, the process of filling the zero-initialize region with ‘0’ may be performed in a word unit.

When the zero-initialize region is entirely filled with ‘0’, a code stored in an EEPROM is copied to a specific region (code region) of the RAM. At this time, the process of copying the code may be performed in a word unit, wherein a step (S103) of determining whether the code is copied to all addresses of the RAM code region and a step (104) of performing the copying operation in a word unit until the code is copied to all the addresses of the RAM code region are progressed repeatedly.

As described above, the RAM initializing process of the prior art may comprise the zero-initializing process of filling the zero-initialize region with ‘0’ and the code copying process of the code of EEPROM to the code region of the RAM, wherein each of the zero-initializing process and the code copying process is performed by a repeated progress of a loop consisting of three commands respectively.

The three commands of the loop (C-1, C-2, C-3) can be expressed as shown in Table 1.

TABLE 1

| | |
|---|---|
| C-1 | Determine whether all the addresses are filled |
| | with ‘0’ (zero-initializing process) |
| | or whether the copying process is completed for |
| | all the addresses (code copying process) |
| C-2 | Fill with ‘0’ in a word unit (zero-initializing |
| | process) or copy the code in a word unit (code copying |
| | process) and then increase the address by a word |
| C-3 | Move to the C-1 command |

From Table 1, it can be seen that among the three commands, a command to perform the operation of filling the zero-initialize region with ‘0’ or copying the code in the RAM initializing process is the C-2 command only, and the C-1 and C-3 commands are not related to the initializing operation. Accordingly, two-thirds of the time consumed for the entire loop operation performing the RAM initializing process is unnecessarily wasted.

### SUMMARY OF THE INVENTION

Accordingly, the present invention has been made to solve the above problems. An object of the invention is to provide a method for initializing a RAM of an electronic device capable of minimizing a time consumed for a RAM initializing process to rapidly make progress a boot-up process of an electronic device such as mobile communication terminal.

In order to achieve the above object, according to an embodiment of the invention, there is provided a method for initializing a RAM of an electronic device comprising steps of: filling a zero-initialize region of the RAM with ‘0’; and copying a code of a ROM of the electronic device to a code region of the RAM, wherein the step of filling the zero-initialize region with ‘0’ comprises steps of determining whether all of N addresses constituting the zero-initialize region of the RAM are filled with ‘0’; and sequentially filling the N addresses with ‘0’ if one or more addresses of the N addresses are not filled with ‘0’ as the determination result.

According to another embodiment of the invention, there is provided a method for initializing a RAM of an electronic device comprising steps of: filling a zero-initialize region of the RAM with ‘0’; and copying a code of a ROM of the electronic device to a code region of the RAM, wherein the copying step comprises steps of determining whether the code is copied to all of N addresses constituting the code region of the RAM; and sequentially copying the code to the N addresses if the code is not copied to one or more addresses of the N addresses as the determination result.

Preferably, the address may be divided in a word unit.

According to the invention, when the process of initializing the RAM of the electronic device, i.e., the zero-initializing process and the code copying process are performed, it is minimized the process of checking whether the zero-initialization and the code copying are completed. In addition, according to the invention, the unit zero-initializing operation and the unit code copying operation, which are substantial initializing operations, are repeatedly executed until all the addresses of the ZI region are filled with ‘0’ or the code is copied to all the addresses of the code region, thereby reducing the time consumed for the RAM initializing process.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart for explaining a RAM initializing process of a mobile communication terminal according to the prior art;

FIG. 2 is a block diagram of a system for initializing a RAM in a typical electronic device; and

FIG. 3 is a flow chart for explaining a RAM initializing process of an electronic device according to an embodiment of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

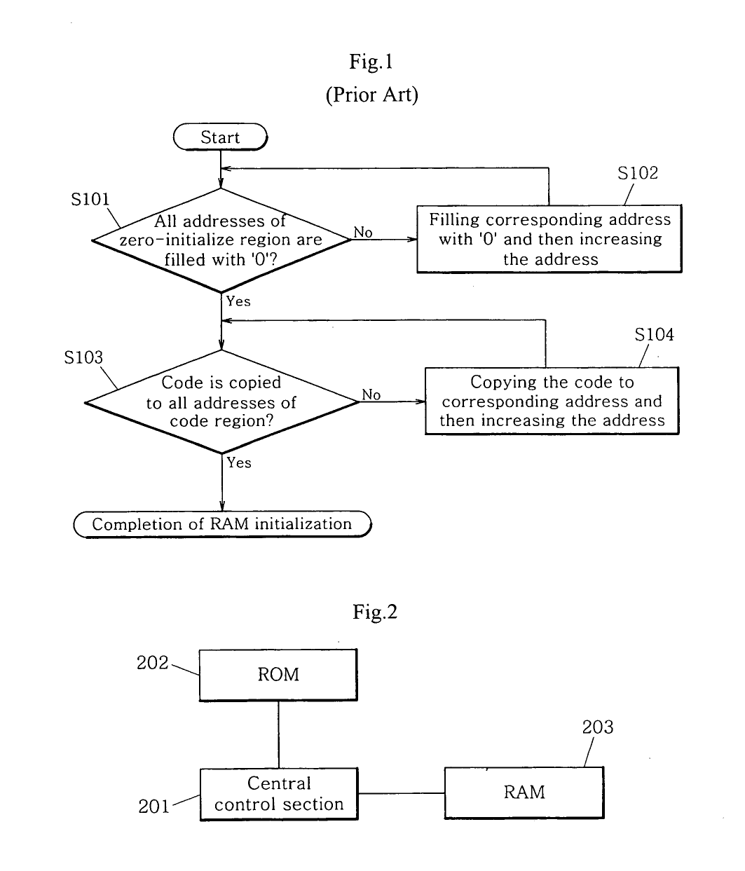

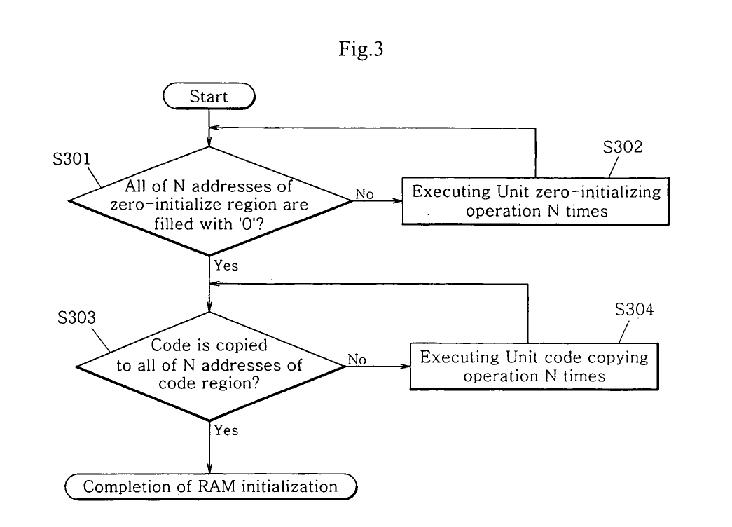

FIG. 2 is a block diagram of a system for initializing a RAM in a typical electronic device, and FIG. 3 is a flow chart for explaining a RAM initializing process of an electronic device according to an embodiment of the invention

An electronic device having an operating system mounted therein, for example a digital recording device, a personal data system, a game machine and the like, essentially comprises a central control section 201 controlling a general operation of the electronic device, and a ROM and a RAM as storing means, as shown in FIG. 2. The ROM is mounted with codes of the operating system of the electronic device and may be embodied with an EEPROM, which is a non-volatile memory. The RAM stores a program required for an operation of the electronic device and a variety of data resulting from the operation. In addition, the RAM stores a code copied from the ROM into a code sector (code region) by an execution of a boot loader in booting up the electronic device. The code sector may consist of addresses in a word unit and the word unit is referred to as 4 byte in a case of a 32-bit micro controller unit (MCU).

In the structure as describe above, it will be described a method for initializing a RAM of an electronic device according to the invention. For reference, the method for initializing a RAM of an electronic device according to the invention is related to the “(2) RAM initializing process” of the detailed booting processes described as the prior art, i.e., (1) the Central processing unit initializing process, (2) the RAM initializing process, (3) the Hardware initializing process and (4) the Task initializing process.

First, as shown in FIG. 3, when a RAM initializing process is started, it is determined whether all N addresses constituting a zero-initialize region (ZI region) are filled with ‘0’ (S301). If one or more addresses of the ZI region are not filled with ‘0’, it is repeatedly performed a Unit zero-initializing operation of filling the ZI region with ‘0’ in a word unit (S302). The Unit zero-initializing operation is meant by an operation of filling an address, which is not filled with ‘0’, with ‘0’ in a word unit and then increasing the address by a word. By repeatedly performing the zero-initializing operation, all the addresses of the ZI region can be filled with ‘0’.

As shown in Table 2, commands required for the zero-initializing process, i.e., the process of filling all the N addresses with ‘0’ can be expressed in a time series manner.

TABLE 2

| Command No. | Commands |
|---|---|
| 1 | Determine whether all the N addresses |
| | are filled with ‘0’ |
| 2 | Fill an address with ‘0’ in a word unit |
| | and increases the address by a word |
| 3 | Fill an address with ‘0’ in a word unit |
| | and increases the address by a word |
| 4 | Fill an address with ‘0’ in a word unit |
| | and increases the address by a word |
| . | . |
| . | . |
| . | . |
| N | Fill an address with ‘0’ in a word unit |
| | and increases the address by a word |
| N + 1 | Fill an address with ‘0’ in a word unit |
| | and increases the address by a word |
| N + 2 | Move to the command No. 1 |

According to the prior art, in performing the zero-initializing process, in order to fill all the N addresses constituting the ZI region with ‘O’, the loop consisting of the three commands, i.e., C-1, C-2 and C-3 in Table 1 is repeatedly executed N times. To the contrary, according to the invention, the zero-initializing process of filling all the N addresses with ‘0’ is completed just by one loop execution.

In addition, the initializing process of the prior art requires 3N commands since the loop consisting of the three commands (C-1, C-2, C-3) are executed N times and the time consumed for the 2N commands of the 3N commands is unnecessarily wasted. To the contrary, according to the invention, the total number of commands required for the initializing process are N+2 and the number of commands for substantially performing the initializing process, i.e., the operations of filling the address with ‘0’ are N. Therefore, according to the invention, the number of commands corresponding to the time that is unnecessarily wasted are two, i.e., command Nos. 1 and N+2 among the total N+2 commands. This is summarized in Table 3.

TABLE 3

| | The present invention | The prior art |
|---|---|---|
| Total number of commands | N + 2 | 3N |
| Number of unnecessary commands | 2 | 2N |
| Ratio of wasted time | 2/(N + 2) | 2N/3N |

In addition, in Table 3, according to the prior art, a ratio of the time wasted by the unnecessary 2N commands is 2N/3N, i.e., 66%. To the contrary, according to the invention, since only the two commands among the total commands (N+2) are unnecessary commands, the ratio of wasted time is only 2/(N+2). Thus, as the addresses of the RAM are increased, in other words, as the electronic device is complicated, the N value in Table 3 is increased in the invention. Accordingly, it is possible to minimize the ratio of wasted time occurred in the RAM initializing process.

In the mean time, when the zero-initializing process of filling all the addresses of the ZI region of the RAM with ‘0’ is completed, it is performed a code copying process of copying a code stored in the ROM to the code region of the RAM. Specifically, as shown in FIG. 3, it is determined whether the code is copied to all the N addresses of the code region of the RAM (S303). If the code is not copied to one or more addresses of the N addresses of the code sector, as the determination result in the step of S303, the Unit code copying operation is repeatedly executed (S304). The Unit code copying operation is meant by an operation of copying the code to an address to which the code is not copied, and then increasing the address by a word. By the repeated execution of the unit code copying operation, it is possible to copy the code to all the addresses of the code region of the RAM.

Commands required for the code copying process are expressed in a time series manner as shown in Table 4.

TABLE 4

| Command No. | Commands |
|---|---|
| 1 | Determine whether the code is copied to |
| | all the N addresses |
| 2 | Copy the code to an address in a word unit |
| | and increase the address by a word |
| 3 | Copy the code to an address in a word unit |
| | and increase the address by a word |
| 4 | Copy the code to an address in a word unit |
| | and increase the address by a word |
| . | . |
| . | . |
| . | . |
| N | Copy the code to an address in a word unit |
| | and increase the address by a word |
| N + 1 | Copy the code to an address in a word |
| | unit and increase the address by a word |
| N + 2 | Move to the command No. 1 |

Similarly to the zero-initializing process shown in Table 2, in the code copying process performed by the commands in Table 4, all the codes are copied to the N addresses constituting the code region of the RAM by one loop execution.

The code copying process of the invention results in that as shown in Table 3 with respect to the total command number and the unnecessary command number required for the code copying process, similarly to the result of the zero-initializing process. Thus, according to the invention, the total command number and the unnecessary command number are N+2 and 2, respectively. To the contrary, according to the prior art, the total command number and the unnecessary command number required for the code copying process are 3N and 2N, respectively.

As described above, when performing the process of initializing the RAM of the electronic device, i.e., the zero-initializing process and the code copying process, it is minimized the number of the commands checking whether the code copying is completed, and the zero-initializing operation and the unit code copying operation, which are substantial initializing operations, are repeatedly executed until all the addresses of the ZI region are filled with ‘O’ or the code is copied to all the addresses of the code region, thereby it can reduce the time consumed for the RAM initializing process.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A method for initializing a RAM of an electronic device comprising steps of:
filling a zero-initialize region of the RAM with ‘0’; and
copying a code of a ROM of the electronic device to a code region of the RAM, wherein the step of filling the zero-initialize region with ‘0’ comprises steps of:
determining whether all of N addresses constituting the zero-initialize region of the RAM are filled with ‘0’; and
sequentially filling the N addresses with ‘0’ if one or more addresses of the N addresses are not filled with ‘0’ as the determination result.

2. The method according to claim 1, wherein the step of sequentially filling the N addresses with ‘0’ comprises a step of repeatedly performing an operation of filling an address with ‘0’ and then moving to a next address to fill the next address with ‘0’ until all of a first address to a N^{th} address of the zero-initialize region are filled with ‘0’.

3. The method according to claim 1, wherein the address is divided in a word unit.

4. A method for initializing a RAM of an electronic device comprising steps of:
filling a zero-initialize region of the RAM with ‘0’; and
copying a code of a ROM of the electronic device to a code region of the RAM,
wherein the copying step comprises steps of:
determining whether the code is copied to all of N addresses constituting the code region of the RAM; and
sequentially copying the code to the N addresses if the code is not copied to one or more addresses of the N addresses as the determination result.

5. The method according to claim 4, wherein the step of sequentially copying the code to the N addresses comprises a step of repeatedly performing an operation of copying the code to an address and then moving to a next address to copy the code to the next address it until the code is copied to all of a first address to a N^{th} address of the code region.

6. The method according to claim 4, wherein the address is divided in a word unit.

7. The method according to claim 4, wherein the step of filling the zero-initialize region with ‘0’ comprises steps of:
determining whether all the N addresses constituting the zero-initialize region of the RAM are filled with ‘0’; and
sequentially filling the N addresses with ‘0’ if one or more addresses of the N addresses are not filled with ‘O’ as the determination result.

8. The method according to claim 7, wherein the step of sequentially filling the N addresses with ‘0’ comprises a step of repeatedly performing an operation of filling an address with ‘0’ and then moving to a next address to fill the next address with ‘0’ until all of a first address to a N^{th} address of the zero-initialize region are filled with ‘0’.

9. The method according to claim 7, wherein the address constituting the zero-initialize region is divided in a word unit.
